(19) United States
(12) Patent Application Publication
(10) Pub. No.: US 2014/0289675 A1
(43) Pub. Date: Sep. 25, 2014

(54) System and Method of Mapping Products to Patents

(71) Applicants: Tyron Jerrod Stading, Austin, TX (US); Roji John, Austin, TX (US)

(72) Inventors: Tyron Jerrod Stading, Austin, TX (US); Roji John, Austin, TX (US)

(21) Appl. No.: 14/261,820

(22) Filed: Apr. 25, 2014

Related U.S. Application Data
(63) Continuation-in-part of application No. 12/544,738, filed on Aug. 20, 2009.

(51) Int. Cl. G06F 3/0482

(52) U.S. Cl. CPC G06F 3/0482
USPC 715/810

(57) ABSTRACT

A data storage device includes instructions that, when executed by a processor, cause the processor to generate a graphical user interface (GUI) including one or more bidirectional mappings between patents and products. The GUI further includes a plurality of user-selectable elements including at least one element selectable by a user to edit a selected one of the one or more bidirectional mappings. Additionally, the instructions, when executed, cause the processor to provide the GUI to a user device.

### CROSS-REFERENCE TO RELATED APPLICATION(S)

This application is a continuation-in-part of and claims priority to pending U.S. patent application Ser. No. 12/544,738 filed on Aug. 20, 2009 and entitled “System and Methods of Relating Trademarks and Patent Documents,” which is incorporated herein by reference in its entirety.

### FIELD

The present disclosure is generally related to systems and methods configured to relate patents to products using directed semantic searching.

### BACKGROUND

The United States Patent and Trademark Office hosts a trademark database, a patent database, and a patent publication database, which are publicly accessible. Similarly, other agencies, such as agencies of other governments around the world, may host similar databases. However, search capabilities for such databases are often limited.

### SUMMARY

In an embodiment, a data storage device includes instructions that, when executed by a processor, cause the processor to generate a graphical user interface (GUI) including one or more bidirectional mappings between patents and products. The GUI further includes a plurality of user-selectable elements including at least one element selectable by a user to edit a selected one of the one or more bidirectional mappings. Additionally, the instructions, when executed, cause the processor to provide the GUI to a user device.

In another embodiment, a system includes an interface to couple to a network, a processor, and a memory accessible to the processor. The memory stores instructions that, when executed by the processor, cause the processor to generate a graphical user interface (GUI) including one or more bidirectional mappings between patents and products. The GUI also includes a plurality of user-selectable elements including at least one element selectable by a user to edit a selected one of the one or more bidirectional mappings. The memory further stores instructions that, when executed, cause the processor to provide the GUI to the network.

In still another embodiment, a method of providing bidirectional mappings between patents and products includes generating a graphical user interface (GUI) including one or more bidirectional mappings between patents and products and including a plurality of user-selectable elements. At least one element of the plurality of user-selectable elements is accessible by a user to edit a selected one of the one or more bidirectional mappings. The method further includes providing the GUI to the network.

### BRIEF DESCRIPTION OF THE DRAWINGS

FIG. 1 is a block diagram of a system including a search system and a correlation system configured to map products to patents according to some embodiments.

FIG. 2 is a block diagram of the search system of FIG. 1 according to some embodiments.

FIG. 3 depicts an embodiment of a trademark record encoded with hypertext markup language (HTML) tags retrieved from the Trademark Electronic Search System through the United States Patent and Trademark Office website.

FIG. 4 depicts a table including data extracted from the trademark record of FIG. 3 aggregated with other text to produce a semantic signature corresponding to a product according to some embodiments.

FIG. 5 is a block diagram of a system to map products to patents according to some embodiments.

FIG. 6 is a block diagram of a system configured to map products to patents according to some embodiments.

FIG. 7 is a diagram of an example of a mapping table indicating a relationship between patents and products according to some embodiments.

FIG. 8 depicts a diagram, in block form, illustrating mappings between patent documents and semantic signatures according to some embodiments.

FIG. 9 is a flow diagram of a method of relating products to patent documents according to some embodiments.

FIG. 10 is a flow diagram of a method of including ancillary data in a report that relates products to patent documents according to some embodiments.

FIG. 11 depicts an embodiment of a graphical user interface to map products to patents according to some embodiments.

FIG. 12 depicts an embodiment of the graphical user interface of FIG. 11 including an example report showing products mapped to patents according to some embodiments.

FIG. 13 depicts an embodiment of a graphical user interface to map patents to products according to some embodiments.

FIG. 14 depicts an embodiment of the graphical user interface of FIG. 13 including an example report showing products mapped to patents according to some embodiments.

In the following discussion, the same reference numbers are used in the various embodiments to indicate the same or similar elements.

### DETAILED DESCRIPTION OF ILLUSTRATIVE EMBODIMENTS

Embodiments of systems and methods are described below that are configured to automatically relate products to patents and patents to products (bi-directionally). In an embodiment, the system may include a processor and a memory storing instructions that, when executed, cause the processor to process documents, press releases, web pages, manuals, and other information from various data sources to produce semantic signatures for each product. In an example, a semantic signature can include content extracted from one or more retrieved files, where the extracted content includes statistically relevant text that relates to a product. The extracted content may be concatenated or aggregated to produce the semantic signature corresponding to the product. In another example, the semantic signature may be an aggregation of statistically significant excerpts extracted from the retrieved files, which excerpts relate to core functionality or features of the product. Over time, with the acquisition of new information, the semantic signature for a given product may be appended or refined with the new information.

The system may automatically generate a query from terms within the semantic signature for a product and use the generated query to search patent documents that relate to a particular product. In some embodiments, the system may utilize features or functionality identified in the semantic signature to generate search queries to search patent claims to identify patent documents including claims that relate to particular features or functionality of the product. In some embodiments, the query may be applied (directed) to claims, title, abstract, and summary section s of the document.

In an embodiment, the computing system may automatically identify associations between products and patent documents through a plurality of attributes, including textual similarity, common ownership, names of people, geographical location, date information, etc. The product information may be extracted from a company website, retrieved from a set of search results, and/or provided by a user. Further, it should be understood that a trademark may represent one possible product identifier for a particular product. Other product identifiers may include a registration number, an application number, a globally unique identifier, another identifier, or any combination thereof. In some embodiments, the computing system may also process trademark records to supplement the product information, and may process the product information against existing classifications, such as United States patent classifications, International patent classifications, industry classifications, and other classifications to identify associations between semantic signatures and patent classifications.

In an example, the computing system may retrieve related to a product identifier from the product owner's website, from tradeshow sites, from various other data sources, or any combination thereof, and may process the retrieved documents to produce a semantic signature corresponding to a particular product identifier. The computing system may then store the semantic signature. Subsequently, the system may search the semantic signature based on key words or terms. Alternatively, the system may automatically generate a query based on the semantic signature and use the generated query to search another data source (such as a patent data source, a litigation data source, a financial data source, or any combination thereof) to identify relationships between the product and one or more patent documents within the set of patent documents based on the semantic signature. In an embodiment, the computing system may further process the mappings to rank or weight each mapping based on one or more ranking algorithms, such as by searching patent claims within the set of patent documents using features and/or functionality identified in the semantic signature.

In some embodiments, the mappings are bi-directional. The computing system may be configured to receive seed data and to provide a set of mappings between product identifiers and patents in response to the seed data. In one example, the computing system may identify one or more patents in response to a product identifier. The term “product identifier” may include a trademark, a product name, a globally unique identifier, an unique number (such as a serial number or record number), or other identifier. The product identifier may also include the semantic signature, or may be associated with or linked to a corresponding semantic signature. In another example, the computing system may identify one or more products in response to a patent number by retrieving the patent, generating a query based on the claims, based on keywords derived from the specification, or any combination thereof, and by searching the semantic signatures based on the generated query.

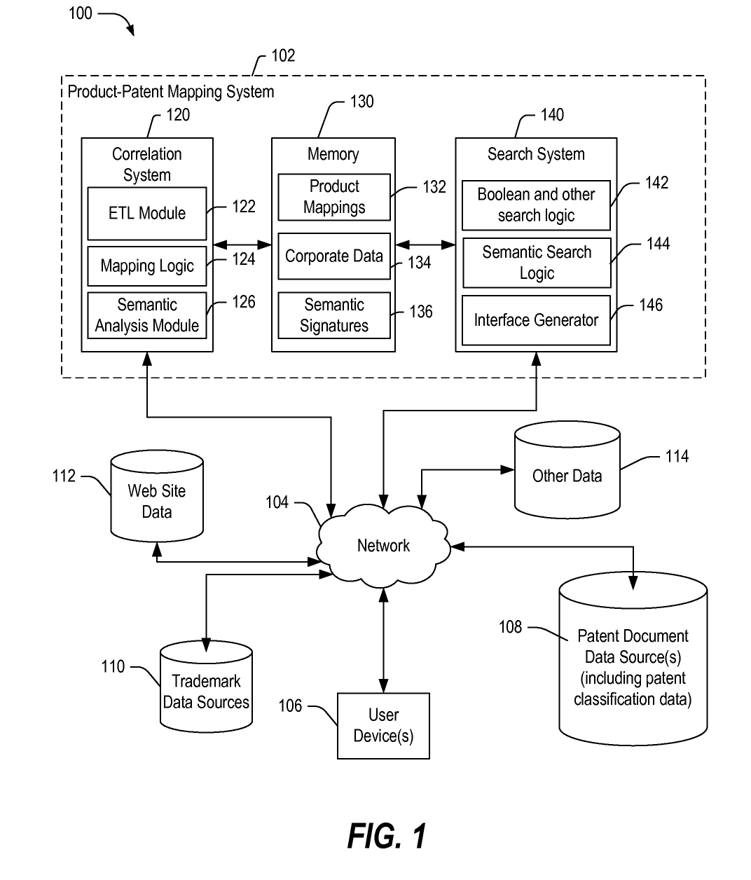

In the following discussion, the term “system” refers to a computing system, which may be any device having a non-volatile memory to store instructions and/or data and having a processor capable of executing the instructions and/or processing the data. Examples of a computing system or system may include, but are not limited to, a personal computer, a computer server, a laptop computer, a smart phone, and a tablet computer. One possible example of a system that may be configured to relate products to patents and vice versa is described below with respect to FIG. 1.

FIG. 1 is a block diagram of a system 100 including a product-patent mapping system 102 including a search system 140 and a correlation system 120 configured to map products to patents and vice versa. System 100 may be coupled to data sources, such as databases, websites, data repositories (e.g., digital libraries, data warehouses, proprietary databases, other data sources, or any combination thereof), and to user devices, such as smart phones, personal computers, or other computing systems through a communications network 104, such as the Internet. In the illustrated example, product-patent mapping system 102 may be coupled to patent document data sources 108, trademark data sources 110, web site data 112, and other data 114 through the network 104. Further, the product-patent mapping system 102 may be coupled to one or more user devices 106 through the network 104.

The patent data source 108 and the trademark data source 110 may include publicly available data, such as patent database records, published patent applications database records, trademark database records, and text from the United States Patent and Trademark Office web site or hosted by other patent or trademark document authorities (such as the European Patent Office, the World Intellectual Property Organization, and other foreign patent authorities), proprietary information, etc., and including classification information, such as patent classifications, trademark classifications, industry classifications, or any combination thereof. Further, in some embodiments, any of the data sources may be hosted by a private company and may include pre-processed patent data.

The other data 114 may include websites, databases, whitepapers, and other public or private data sources accessible to product-patent mapping system 102. In some instances, the other data 114 may include enterprise resource planning (ERP) data and other data that is proprietary to a particular company. Further, the other data 114 may include documents and/or data that may be uploaded to the product-patent mapping system 102 by a user.

The correlation system 120 includes an extract-transform-load (ETL) module 122 configured to extract text, metadata, link information and other data from retrieved documents and web pages. In an embodiment, the ETL module 122 may extract, transform, and load data received from one or more data sources into a table or matrix. Further, the ETL module 122 may be configured to implement one or more ETL processes to extract, process, and load data of various types and various formats and to populate the table or matrix. In an example, the ETL module 122 extracts trademark data from a plurality of trademark records. Such extracted data may include numeric identifiers (such as trademark application numbers and registration numbers), trademark names, trademark descriptions of goods and services, ownership data, date information, and trademark classifications data. The ETL module 122 can also be used to extract patent data from the plurality of patent documents, such as ownership data, date information, claim text, classifications, and so on. The ETL module 122 may be configured to extract data from any text document, including hypertext markup language (HTML) and extensible markup language (XML) documents, PDF documents, and other documents and other document formats. The ETL module 122 may also be used to extract data from various types of databases, including SQL databases, for example.

The correlation system 120 further includes mapping logic 124 configured to relate the extracted data (text, metadata, link information, and other data) to pre-processed data, such as patent data, trademark data, product information, related financial information, and the like. In some examples, the mapping logic 124 processes the extracted trademark data to produce a semantic signature corresponding to the trademark record from the trademark data source 110. The mapping logic 124 may process the data extracted from one or more of the trademark records and may generate a query to search the patent document data sources 108 to identify mappings between a patent document and the product identifiers (trademark) based on available information. In some embodiments, the mapping logic 124 may be configured to process selected terms extracted from available product information (which may have been retrieved by search system 140 or provided by the user) against text from each patent document to produce the mappings between products and patent documents, which may be treated as preliminary mappings that may be further refined through semantic analysis of claims of the patents and text from the available product literature. In some examples, the mapping logic 124 can process selected terms extracted from the available product information against one or more existing classifications, such as text of United States patent classifications or International patent classifications, to categorize the available product information within one or more of the existing classifications. Additionally, the mapping logic 124 can be used to map the other data 114 to trademark data, patent document data, product information, or any combination thereof. In some embodiments, the other data 114 may be extracted and appended to previously extracted data to form, supplement, or refine a semantic signature corresponding to a product. Additionally, the other data 114 may include litigation data, financial data, proprietary data, business intelligence, other data, or any combination thereof.

The correlation system 120 may include a semantic analysis module 126 that may be configured to process the extracted data to generate a semantic signature. In some embodiments, the semantic analysis module 126 may be configured to operate in conjunction with the mapping logic 124 to map products to patents. In an embodiment, the semantic analysis module 126 may identify statistically relevant textual excerpts from web pages, white papers, product literature, and other data sources and may concatenate the excerpts into a single document or database record to produce the semantic signature. In some examples, multiple documents that relate to a particular product (which also may be identified by a registered or applied-for trademark) may be associated with the particular product and may be separately processed using the semantic analysis module 126 to generate a semantic signature corresponding to the content of each of the multiple documents and may combine the semantic signatures into a single document to produce a semantic signature corresponding to a product. In an embodiment, the semantic analysis module 126 may extract and concatenate text from the various documents, which text corresponds to functionality and/or structural components of the product. Further, the semantic analysis module 126 may process the semantic signatures of the multiple documents to produce a semantic signature for the product based on the multiple documents, for example, by concatenating the relevant excerpts into a single file. In an embodiment, the correlation system 120 may store the semantic signatures in the memory 130 (e.g., semantic signature 136).

The product-patent mapping system 102 further includes a memory 130 configured to store product mappings 132, corporate data 134, and semantic signatures 136, which may include semantic signatures and data correlating the semantic signatures to products. The memory 130 may be accessible to the correlation system 120 and to the search system 140.

The search system 140 includes Boolean and other search logic 142, which may be executed to perform searches and document retrieval operations on various data sources, including the web site data 112, the other data 114, the trademark data sources 110, and the patent document data sources 108. The search system 140 further includes semantic search logic 140 configured to generate queries based on a semantic analysis of a semantic signature and to perform semantic searches on various data, including the semantic signatures as well as data retrieved by Boolean and other search logic. In some examples, the semantic search logic 140 may automatically perform a directed semantic search on a set of documents retrieved by Boolean and other search logic 142, on a subset of the semantic signatures 136 identified by the Boolean and other search logic 142, or any combination thereof. A “directed semantic search” refers to a semantic search within an identified subset of documents in a document space and/or within portions of the documents of the subset (such as within pre-determined sections of the documents). The search system 140 may further include an interface generator 146 that may produce a graphical user interface for presentation of search results, reports, mappings, and so on. The graphical user interface may also be configured to receive user inputs, such as text inputs, button selections, and other inputs to configure user-selected filters or options.

As discussed above, the product-patent mapping system 102 is configured to map products to patents bi-directionally. In some embodiments, a user may interact with the graphical user interface to initiate the mapping process, such as by providing seed data. Such seed data may include a company name, a trademark, a patent, a set of product names, a set of patents, other information, or any combination thereof. In some examples, a user may upload one or more product names. The product-patent mapping system 102 may search trademark data sources 110 to determine the owner of one or more of the products (assuming that the products are trademarked) or assuming that a relationship between a product and the trademark may be determined. Further, the product-patent mapping system 102 may search the web site data 112 and the other data 114 to identify the owner. Once identified, the product-patent mapping system 102 may retrieve documents corresponding to the product from various data sources, including the owner's web site.

Further, the graphical user interface may provide an upload link to allow the user to upload a list of products, a list of patents, a list of trademarks, other information, or any combination thereof. Additionally, the graphical user interface may include an upload link to allow the user to upload any documents (such as manuals, white papers, press releases, etc.) that the user has in his/her possession, which may relate to a product. The product-patent mapping system 102 may use semantic analysis module 126 to perform a semantic analysis on the retrieved documents and data to produce a semantic signature for each product. The product-patent mapping system 102 may then use mapping module 124 and semantic search logic 144 to search patent document data sources 108 (or a subset of patent documents) to identify (or generate) search results, which may be provided to the semantic analysis module 126 to identify product-patent mappings. In some examples, the product-patent mapping system 102 may automatically generate a query based on the semantic signature and may search patents based on the query. In other examples, the product-patent mapping system 102 may automatically generate a query based on a patent document and may search the semantic signatures 136 based on the query.

In some embodiments, the system 102 may utilize the interface generator 146 to produce a graphical user interface (GUI), which may provide one or more options that may be selected by a user to define the product-patent mapping operation. For example, an individual may upload a product list of his/her company's products and may select an option to map the company's products to its patent documents. One reason to produce such a mapping may include a potential tax benefit. For example, in the United Kingdom, a company may receive a tax benefit if the company's patents can be shown to cover the company's products. Another reason to produce such a mapping may include generating a report as a starting point for verification of patent coverage for product marking purposes. Alternatively, an individual may select an option to map his/her company's products to other patents to perform an initial risk analysis. In yet another embodiment, the individual may select an option to map another company's products to his/her company's patents and so on. Further, the process may operate in reverse, mapping patents to products, such as by retrieving a patent portfolio of a company, identifying companies that operate in similar product spaces (through patent classification codes, industry codes, etc.), identifying a list of products for each of the companies (through trademark associations, website searches, or data provided by the user), generating a semantic signature for each product from available information, and then mapping the products to the patents. Alternatively or in addition, the product-patent mapping system 102 may search various data sources to retrieve documents corresponding to the product, extract data from the documents, and correlate the data (and documents) to one or more existing semantic signatures and/or to generate a new semantic signature, which may be used to identify mappings from patents-to-products.

Each product-patent mapping represents a bi-directional association (product-to-patent and patent-to-product) based on semantic associations between the semantic signature of a product and the text of the patent document. Such semantic associations may include keyword matches between the semantic signature assembled from the product literature and words extracted from the patent claims. Each product identifier may be mapped to a patent document through multiple matches or associations and using the semantic signature generated from information retrieved from various sources. Further, each trademark record may be mapped to multiple patent documents (and vice versa). In this instance, the trademark record is essentially a product identifier; however, some products may not have a corresponding federal trademark registration. Accordingly, the product-patent mapping system 102 may be configured to generate product-patent mappings based on available product information, whether such information is extracted from the product literature, provided by the user, extracted from trademark records or from some other source, or any combination thereof.

The product-patent mappings can be used as a “Rosetta Stone” to translate search terms, concepts, and extracted data between patent documents, product literature and trademarks in order to identify relationships. Further, the product-patent mappings may be used to translate search terms, concepts, and extracted data between different data sources, between different data types (e.g., financial data and technical data), etc. In some embodiments, the product-patent mappings may be used to relate search results from a first data source to product data or patent data through a third data source that is already correlated to the patent documents (or more generally to the patent classifications). Further, the product-patent mappings may be used to relate ancillary data (such as financial data, litigation data, or other data) to a product, to a patent, or both.

In some embodiments, the Boolean and other search logic 142 can translate search queries received from a user device 106 into multiple formats and/or multiple queries (using query expansion and query refinement techniques) for searching different data sources. For example, the one or more patent document data sources 108 may include multiple databases, which may use different data structures and which may be accessible through search structures. In one example, a first patent document data source can be queried using Boolean search logic (including logical operators such as AND, OR, ANDNOT, and the like) and a second patent document data source uses different indicators (such as “+” and “−”) to indicate logical operations. Other data sources, such as the other data 114, may use proprietary query structures. The Boolean and other search logic 142 may be configured to translate a received query into formats appropriate for each data source, to send the translated queries to the various data sources, and to process search results into a set of search results.

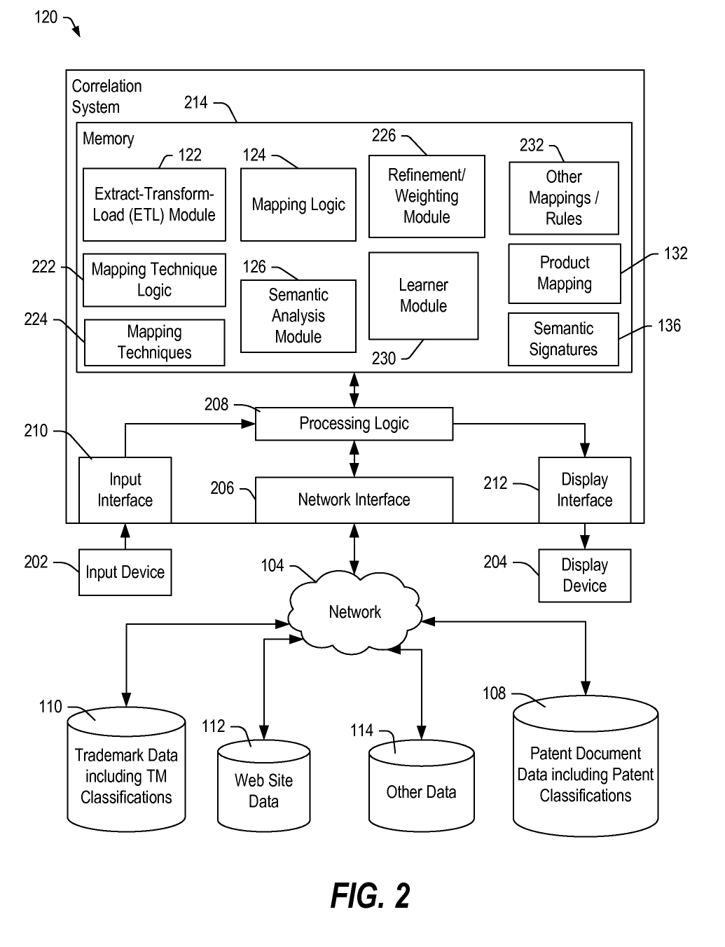

FIG. 2 depicts, in block form, a representative example of some embodiments of the correlation system 120 illustrated in FIG. 1. The correlation system 120 may include a network interface 206 that communicates with the network 104. The network interface 206 may be coupled to processing logic 208, which may include one or more processors configured to execute instructions and to process data. The processing logic 208 is coupled to a memory 214, to an input device 202 through an input interface 210, and to a display device 204 through a display interface 212.

The memory 214 includes the ETL module 122 that is executable by processing logic 208 to extract, transform, and load data from a variety of data sources, including the trademark data source 110, the web site data 112, the other data 114, and the patent data 108 into tables. The memory 214 also includes the mapping logic 124 to identify associations between the extracted data and data from other data sources, such as the patent data source 108 to produce mappings between products and patents (i.e., the product mappings 132).

Additionally, the memory 214 includes the mapping technique logic 222 configured to select the one or more mapping techniques 224 based on a type of data to be mapped. For example, mapping of a numeric identifier to a matching numeric identifier in another document may be performed using a simple search. In some examples, extraction of text from product information and/or mapping of semantic signatures to patent documents may utilize more robust mapping techniques, such as latent semantic analysis, a naive-Bayes classification, Latent Dirichlet Allocation (LDA), other types of natural language processing techniques, or any combination thereof, to determine semantic relationships between patent documents and semantic signatures that correspond to products. In other examples, mapping of a product owner to an assignee or inventor of a patent may utilize a two-tier, “brute force” (term-by-term) search, involving a look up to a table of pre-defined globally unique identifiers (which can including mappings of variations in spelling of a corporate name or individual name to an unique identifier) and including a search using the globally unique identifier. Other types of mapping techniques can also be used. The mapping technique logic 222 is adapted to select an appropriate mapping technique for a given piece of data and to the control mapping logic 124 to selectively apply the selected mapping technique.

In some embodiments, the mapping logic 124 may apply each possible mapping technique to each piece of data and aggregate the results to produce a composite weighted mapping value for each piece of data. In other embodiments, the mapping logic 124 selectively applies different mapping techniques based on which attribute is being mapped (i.e., product owner as compared to the semantic signature of a particular product).

The refinement/weighting module 226 may be executable by the processing logic 208 to selectively refine one or more mappings between a particular product and a particular patent document or between a product name (trademark) and a patent document. In some embodiments, the refinement/weighting module 226 may be accessible by a user through the input device 202 to manually adjust mappings, such as by pruning duplicate mappings, removing erroneous mappings, etc. In some embodiments, the refinement/weighting module 226 may operate in the background, automatically adjusting or refining mappings based on data retrieved from other data sources 114, such as ancillary data derived from web sites. Further, the refinement/weighting module 226 may be configured to selectively adjust mapping scores, such as by adjusting weights or relevancy rankings assigned to each mapping.

In some embodiments, the refinement/weighting module 226 can adjust a mapping between a service mark and a patent classification by limiting such a mapping to “business methods” types of patent classifications, such as United States Patent Classifications 705 through 707, for example, and pruning or otherwise devaluing ranks of other classifications. In some embodiments, the refinement/weighting module 226 can adjust a mapping between a product and a patent document based on ancillary data, such as data extracted from a whitepaper that includes functional and/or structural details of a product, which details can be included in a semantic signature associated with the product. The mapping logic 124 may utilize the semantic signature to identify functional descriptions and/or features of the product within the product literature that can be used to correlate the product to the patent document to produce a product-patent mapping and/or to further refine an existing mapping. In some embodiments, the refinement/weighting module 226 can adjust a mapping between a product and a patent document based on document statistics derived from the trademark data source 106, the patent data source 108, the other data 114, data uploaded by the user, or any combination thereof.

In some embodiments, the memory 214 can include the learner module 230, which can be trained to map new data into an existing set of classifications or categories to provide a first level association. In some embodiments, the product mappings 132 between products and patent documents 132 may be incomplete (such as when new trademark applications are filed, new classifications are added, new product information is uploaded etc.) or may include descriptive terms that do not match with existing data. In some embodiments, the learner module 230 can be used to apply the mapping logic 124 to identify related information and/or to associate new information with the set of classifications. In some embodiments, the learner module 230 can use a bounded learning model where the target function for mapping the data has a real-valued output scaled to a probability between zero and one. The learner module 230 may be trained through a learning session that includes a set of trials. In each trial, the learner module 230 may be given an unlabeled set of text documents, such as an unlabeled set of patent documents (with patent classification data removed), which it can classify or associate with the set of patent classifications (for example). The learner module 230 may apply a current hypothesis (or set of mapping rules and mapping techniques) to predict a probability for each document relative to, for example, each of the international patent classifications and makes an estimate for each patent document as to which class or classes it belongs. The learner module 230 may then be provided the correct mappings (i.e., the actual patent classifications for each patent document). The learner module 230 may be configured to adjust its hypothesis to reduce errors and to repeat the learning process with another training set. Over a number of learning trials, the learner module 230 may improve its performance. In some embodiments, the learner module 230 may be configured to tweak parameters associated with the mapping techniques 224 to improve its mapping to a desired performance level.

Once the learner module 230 is trained, new data provided to the learner module 230 (such as extracted trademark data, semantic signatures, and/or other data) can be readily associated with a given patent classification, making it possible to dynamically relate new data or queries (for example) to one or more related patent classifications. While such general associations are not reliable to surface precise results, the associations to the classifications can be used to narrow or direct a search within a particular subject area, making it possible to surface trademarks related to random query terms (or patents that relate to particular product identifiers), even when direct the product mappings 132, for example, do not include such mappings.

In some embodiments, mapping of text to international patent classifications may be preferred over mapping of text to trademark classifications, in part, because there are more classes and subclasses within the international patent classifications, providing relatively more granularity within the classifications. However, other types of classifications may also be used, including, for example, industry classifications, proprietary classifications, and the like. Alternatively, multiple different types of classifications may be used to produce a web of classifications to which each document may be associated. Further, multiple learner modules, such as the learner module 230, can be included and can be trained to map different types of data to the same set of classifications, providing translation to associate different types of data to the set of classifications. In some instances, it may be possible to train learner module 230 to map between different languages, so that, for example, untranslated texts can be mapped to the set of classifications as well.

The learner module 230 can be a bounded learner, such as that described above, or another type of learner, such as an artificial intelligence, a neural network, a rule-based learner, or some other algorithm designed to dynamically adjust its performance and/or to utilize the mapping logic 124, the mapping technique logic 222, and the mapping techniques 224 to enhance its performance. In some embodiments, the learner module 230 may control and coordinate operation of the ETL 122, the mapping technique logic 222, the mapping logic 124, and the refinement/weighting module 226 to produce the product mappings 132 (between products and patents, and between products and other data, such as financial data, litigation data, owner data, inventor/author data, and the like).

It should be understood that modules 122, 124, 222, 226, and 230 are depicted for illustrative purposes only. Not all of the modules may be needed in every implementation. Further, in some embodiments, modules may be combined and other modules may be added without departing from the scope of this disclosure. Additionally, though the product mappings 132 are depicted within the memory 214, it should be understood that they may be stored in a database that is external to correlation the system 120. Further, in some instances, other mappings and/or mapping rules may be stored with the product mappings 132 in a single data store.

The following discussion relates to mapping of a trademark record to a patent document. However, this example is provided for simplicity. The trademark record represents an identifier of a product that can be associated with a semantic signature. The description of goods and services of the trademark record, the owner information, date information, and other information can be used to supplement and refine the semantic signature and/or the relationship mappings.

In an embodiment, the semantic analysis module 126 may profile a set of documents and/or product records to produce sparse matrices, where each matrix includes rows corresponding to terms within the respective product records and includes columns corresponding to the respective documents. In this instance, each product record may be treated as a document. The system may scrape data from corporate web sites and other data sources to add terms to the semantic signature using the ETL module 122. The matrix of Equation 1 below depicts such a term-document matrix of either a plurality of trademark records or a plurality of patent documents. Each unique trademark term (tᵢ) is assigned to a row and each document (dⱼ) is assigned to a column of the matrix. The values (x) within the matrix correspond to a number of hits or instances of a particular term (x) in a particular document (d).

$$[ {t}_{i}^{T} , {d}_{j} ] -> [ \begin{matrix}{x}_{1 , 1} & … & {x}_{1 , n} \\ ⋮ & ⋱ & ⋮ \\ {x}_{m , 1} & … & {x}_{m , n}\end{matrix} ] \qquad ( Equation 1 )$$

Within the matrix of Equation 1, term-document relationships are quantified according to the occurrence of each term within each document. Terms within the term-document matrix need not be “stemmed” because latent semantic analysis (LSA), applied by mapping logic 124, intrinsically identifies relationships between words and their stem forms (e.g., between “computing,” “compute,” and “computer”). As used herein, the term “Latent Semantic Analysis” or “LSA” refers to a technique in natural language processing for analyzing relationships between a set of documents and the terms contained therein by producing a matrix that describes the occurrences of terms within the documents. Terms and their respective stems are intrinsically identified using LSA because LSA relies on the relative frequency of a word and its neighboring content words, assuming that two words are similar if they have similar neighboring content words. Accordingly, stems are inferred from contextual statistics. Thus, mapping logic 124 can operate in conjunction with ETL module 122 to associate each unique term to a row, where the unique term represents each of the forms of a given word.

Product term vectors for each row of the product sparse matrix and patent term vectors for each row of the patent sparse matrix may be calculated. In particular, mapping logic 124 applies LSA to calculate the term vectors. Since both matrices have the unique terms, the respective vectors can be compared to identify word matches. In an example, a row of the matrix represents a vector corresponding to a particular term within, for example, a plurality of trademark records, defining a relation between the particular term and each product record or patent document according to Equation 2.

tᵢ^{T}=[x_{i,1} . . . x_{i,n}] (Equation 2)

Product record vectors for each column of the product sparse matrix and patent document vectors (v) for each column of the patent sparse matrix are calculated. In particular, mapping logic 124 uses LSA to reduce the profiled matrix or matrices into document vectors defining each document's relationship to each term in the document space. The respective document vectors relate each of the patent documents and trademark records to the same set of trademark terms. Thus, a column of the matrix depicted in Equation 1 represents a document vector corresponding to a document within the matrix and defining a relationship between the document and each term according to Equation 3.

$${d}_{j} = [ \begin{matrix}{x}_{1 , j} \\ ⋮ \\ {x}_{m , j}\end{matrix} ] \qquad ( Equation 3 )$$

In some embodiments, it is possible to calculate relevance across a given document space based on the document and term vectors. For example, a dot-product between two term vectors gives a correlation value between the two terms over all of the documents (i.e., a set of documents that include both terms). A dot-product between two document vectors gives a correlation value between the two documents over all of the terms of the document space (i.e., a set of terms contained in both documents). By confining the patent matrix to unique terms, the products and patent documents are related through commonality of the unique terms. A dot-product operation may be performed on each term vector and each document vector to produce a plurality of mappings between products and patent documents.

Optionally, it is possible to utilize the product sparse matrix and the patent document sparse matrix to generate concept mappings between products and patent documents. Such a concept mapping can be vector representing a single value term mapped across a document space. In an embodiment, the product and patent sparse matrices may be factored into respective singular value decompositions. For example, it is possible to factor the matrix depicted in Equation 1 above into a singular value decomposition in the form of M=UΣV*, where U is a m-by-m unitary matrix over the space k, the matrix Σ is an m-by-n diagonal matrix with non-negative real numbers on its diagonal, and V* represents a conjugate transpose of the document vectors (i.e., the column vectors of the matrices). Selecting the largest singular values of concepts (k) and their corresponding singular vectors returns a relevancy ranking across the document space with a minimum error. Further, the resulting “decomposed” term and document vectors can be treated as a “concept space” where the decomposed term vector includes (k) concept entries representing the occurrence of term (xᵢ) in one of the k concepts, and the decomposed document vector gives a relationship between each document (dⱼ) and each concept (kᵢ). The resulting conceptual approximation can be represented by Equation 4.

Xₖ=UₖΣₖVₖ^{T} (Equation 4)

Equation 4 makes it possible to compare documents in a concept space by comparing decomposed document vectors, for example using cosine similarity, to identify clusters of documents. Cosine similarity refers to a technique of determining a cosine angle between two vectors (such as two term vectors or two document vectors), where the angle represents a measure of similarity between the two vectors. An example of document vector singular decomposition is depicted in Equation 5.

dⱼ=UₖΣₖ\hat{d}ⱼ (Equation 5)

Here, the document vector is decomposed using the unitary matrix (U) and the diagonal matrix (Σ). The inverse decomposition is depicted in Equation 6.

\hat{d}ⱼ=Σₖ⁻¹Uₖ^{T}dⱼ (Equation 6)

Alternatively, comparing decomposed term vectors provides a clustering of terms within a concept space. To handle queries, such as query q, terms are first translated into the concept space using the singular value decomposition, as depicted in Equation 7.

\hat{q}=Σₖ⁻¹Uₖ^{T}q (Equation 7)

Once translated, such queries \hat{q} can be applied to the document or term vectors to identify document clusters or term clusters, conceptually, based on the query term.

Once the matrices are factored, a selected product term vector may be translated to its respective single value decomposition to produce a singular-value term vector. Such translation is similar to that depicted in Equations 6 and 7, except that the term (tᵢ) is used as the query (q). The single value term vector may be compared to the single value decomposition of the patent sparse matrix to identify matches, where each identified match corresponds to a conceptual mapping of a product to a patent document. In particular, the identified matches represent instances where a product variable, such as a product identifier, attribute or term, overlaps with a patent document attribute or term. Such overlaps may indicate a relationship. A dot-product operation may be performed on each term vector and each document vector to produce a plurality of mappings between products and patent documents and optionally singular value matches. In an example, the singular value matches may be added to the plurality of mappings derived from the dot-product operations.

This method can be repeated when any one of the trademark data source 110, the semantic signatures 136, and the patent document data 108 are updated to map newly added information into the existing matrices. Further, this method can be repeated, iteratively to identify the plurality of product-patent mappings 132 or 502.

It should be understood that LSA represents only one of many different ways of identifying mappings between products and patent documents. Several alternatives or modifications to LSA are described below.

One such alternative technique for relating products to patent documents includes a latent Dirichlet allocation (LDA) analysis. As used herein, the term “latent Dirichlet allocation” and “LDA” refer to a generative probabilistic model (i.e., a three-level hierarchical Bayesian model) for collections of discrete data, such as text corpora, in which each item of a collection is modeled as a finite mixture of topics over an underlying set of topics. In LDA, the topic distribution is similar to probabilistic latent semantic analysis except that LDA assumes the topic distribution to have a prior probability distribution representing a priori knowledge or belief about an unknown quantity before any data is observed. In LDA, a document is classified by selecting a distribution over topics and, given this selected distribution, picking a topic of each specific word. Considering the words to be independent of the topics, the words are assigned to particular topics.

In some embodiments, where LDA is used in lieu of LSA, an LDA process may be performed on the profiled data. Once profiled, statistics may be calculated to determine a document model of a probability that a given term is within a set of documents. Such probabilities can be based, in part, on term frequency and inverse document frequency statistics to produce the plurality of product-patent mappings 132 or 502.

In some embodiments, Bayesian inference can be used to learn the various distributions (i.e., the sets of topics, their associated word probabilities, the topic (classification) of each word, and the particular topic mixture of each document). One technique includes using a variable Bayes approximation of an a posteriori distribution to learn the various distributions. Alternatively, a learner, such as a neural network or artificial intelligence system, can be trained to learn the various distributions based on a training set, such as a pre-classified set of trademark records that or a set of product-patent mappings that is assembled manually.

In some embodiments, a naïve-Bayes classifier can be used to identify such mappings. The naïve-Bayes classifier is a probabilistic classifier based on applying Bayes' theorem with naive independence assumptions, which assume that the presence or absence of a particular term of a class is unrelated to the presence or absence of any other feature. In this instance, the naïve-Bayes classifier can be used to determine probabilities that particular product descriptor terms may be used in patent documents as discussed below.

Naïve-Bayes classifiers can be trained using a known document space. Abstractly, the probability model for a naïve-Bayes classifier is a conditional model that is conditioned over a dependent class variable for a small number of outcomes or classes, conditioned on several variables. The conditional model can be formulated using Bayes' Theorem under various independence assumptions to define the conditional probability distribution (p) according to Equation 8, for example.

$$p ( C \vert {F}_{1} , … , {F}_{n} ) = \frac{1}{Z} p ( C ) {\prod }_{i = 1}^{n} ( {F}_{i} \vert C ) ) \qquad ( Equation 8 )$$

Such a classifier can be trained, for example, using a subset of patent documents to selectively map patent documents to patent classifications, for example. Since the patent documents are already assigned to patent classifications, the mappings (however flawed) already exist, and the classifier can map the documents to the classifications and learn by comparing the mappings to existing mappings.

In some embodiments, naïve-Bayes classifier can decouple the class (category or attribute) conditional feature distributions, which means that the classifier can independently estimate each distribution as a one dimensional distribution, assisting in alleviating problems stemming from expanding, multi-dimensional data sets and allowing the system to scale with the number of features. Under a maximum a posteriori estimator, the naïve-Bayes classifier can arrive at a correct classification when the correct class is more probable than any other class. Thus, a naïve-Bayes classifier can work well for “general proximity” type of mappings, where the class probabilities do not have to be estimated with great specificity and accuracy, but where a general proximity-type of mapping can be relied upon to narrow a search space or to direct or focus further searching.

Though LSA, LDA, and naïve-Bayes techniques are discussed above as separately applied operations, in some instances, it may be desirable to apply each of those operations and to selectively combine the results to refine the mappings. In some embodiments, the system may apply different mapping strategies for different categories of data. In some embodiments, learner module 230, depicted in FIG. 2, may control mapping technique logic 222 and mapping logic 124 to apply one or more mapping strategies based on the type of information. For example, a first mapping strategy may be used to map product owner data to patent assignee data and a second may be used to map product information to patent classifications from the United States Patent and Trademark Office website. In this example, mapping of owner-to-assignee data can utilize a two-tier “brute force” type of search with reasonable accuracy. In such an approach, company information and individual names can be pre-processed to a set of globally unique identifiers. For example, a company name such as IBM may have multiple different typographical variations, such as “IBM,” “Int'l Bus. Machs.,” “International Business Machines Corporation,” etc. Each variation can be mapped to the same globally unique identifier (i.e., each variation is assigned to the same globally unique identifier, e.g., IBM=“123”). In this example, to map a trademark owner to a patent assignee, a first search is performed to search the product owner data within the set of globally unique identifiers to retrieve its globally unique identifier. Then, a second search is performed on the patent documents, which may already be indexed to include the respective globally unique identifiers, to identify product owner to patent assignee mappings. Similarly, where the product owner is an individual, a globally unique identifier for the individual's name can be retrieved, and patent documents can be searched based on the globally unique identifier for the individual's name.

In contrast, mapping of product information to a patent document or an international patent classification may utilize more robust mapping algorithms, such as LSA, LDA or naïve-Bayes classifiers as described above. Such classifications can associate semantically related data without requiring exact matches, providing conceptual mapping or category mapping over less-structured portions of the data. In an embodiment, learner module 230 can control mapping logic 124 to apply each of the algorithms to each piece of information and to aggregate the results to determine a probabilistic relationship. Further, mapping of description text to a particular product identifier may include document retrieval, text extraction, text analysis, and so on, which may be performed automatically to link documentation to the product.

Additionally, the system may acquire text data corresponding to a particular product name by scraping such data from the website of the owner/manufacturer of the product. The text data may be processed to produce a semantic signature that may be used in conjunction with such mapping algorithms to define and/or refine product-patent mappings 132.

Accordingly, mapping logic 124 selectively applies a desired mapping algorithm based on what data is being mapped. As discussed above, learner module 230 controls mapping technique logic 222 to select one or more mapping techniques 224 and provide selected mapping techniques to mapping logic 124 for mapping the data.

In an embodiment, a term frequency value (tf_{i,j}) and an inverse document frequency (idfᵢ) value may be calculated for the selected term (tᵢ) relative to each search result (dⱼ). Term frequency can be understood as a statistical value that is the number of occurrences of the considered term (n_{i,j}) normalized over the sum of number of occurrences of all terms in document (n_{k,j}) to provide a measure of importance of the term within the document as depicted in Equation 9.

$${tf}_{i , j} = \frac{{n}_{i , j}}{{\sum }_{k} {n}_{k , j}} \qquad ( Equation 9 )$$

Inverse document frequency is a measure of general importance of each term over the document space (D), which is obtained by dividing the number of all documents (D) by the number of documents containing the term (tᵢ) and then taking the logarithm of that quotient as depicted in Equation 10.

$${idf}_{i} = log \frac{\vert D \vert}{\vert \{ d \text{:} {t}_{i} ∈ d \} \vert} \qquad ( Equation 10 )$$

The term-frequency inverse-document frequency calculations provide an example of a method of calculating a value that can be used to weight each mapping.

In an embodiment, the refinement module 226 may be used to selectively weight the product-patent mappings 132 using one or more ranking algorithms to produce weighted mappings. In one example, the term frequency can be divided by the document frequency for each individual mapping to generate a weighting value, which can be assigned to the mapping. In another example, the term frequency and the inverse document frequency can be multiplied to produce a product that represents a weighting for each mapping.

In an embodiment, mappings associated with terms of an attribute are aggregated together, for example by refinement/weighting module 226 illustrated in FIG. 2, to produce an aggregated weighted value mapping an attribute of a particular product to a patent document. In another embodiment, refinement/weighting module 226 aggregates mappings associated with each term of semantic signature for a given product to produce a singular aggregated weighted mapping for each product relative to each patent document.

While the above-example uses a term-frequency inverse-document-frequency technique for weighting mappings derived from a “brute force” type of search, other techniques may also be used. For example, LSA and Naïve-Bayes mapping techniques inherently generate a probability or weighting for each mapping. In such instances, the term-frequency inverse-document-frequency weighting technique can be omitted. Alternatively, the term-frequency inverse-document-frequency can be used to enhance the probabilities to surface related results first when a search term exactly matches a rare term of one of the matrices. In an example, term frequency and inverse document frequency values can be used to scale a value associated with a particularly rare term to ensure the results of the rare term are listed at the top of a set of search results when a query includes the rare term.

In another example, another ranking algorithm can be used, such as a BM25 ranking function, sometimes referred to as the “Okapi BM25,” which was described in an article authored by S. Robertson, H. Zaragoza, and M. Taylor entitled “Simple BM25 Extension to Multiple Weighted Fields,” In Proceedings of the Seventeenth International Conference on Computational Linguistics, pp. 1079-1085 (1988). BM25 identifies meta-data elements in a document and organizes data according to such elements. The BM25 approach can use document statistics to weight a particular document relative to other documents in the space. In an example, the BM25 ranking function ranks documents based on query terms appearing in the document, regardless of the inter-relationship between the query terms, such as their relative proximity. The BM25 ranking function includes several different scoring functions. One example is depicted in Equation 11 below.

$$score ( D , t ) = {\sum }_{i = 1}^{n} ( log \frac{{N}_{d} - n ( {t}_{i} ) + b}{n ( {t}_{i} ) + b} ) \cdot \frac{f ( {t}_{i} , D ) \cdot ( {k}_{1} + 1 )}{f ( {t}_{i} , D ) + {k}_{1} \cdot ( 1 - b + b \cdot \frac{\vert D \vert}{ave\_doc \_length} )} \qquad ( Equation 11 )$$

In Equation 11, the parameters k₁ and b are free parameters, which can be chosen to achieve a desired scale. In one example, parameter k1 equals 2.0 and parameter b equals 0.75. Further, variable D represents the document and variable N_{d} is the total number of documents in the collection. The variable n(tᵢ) represents the number of documents containing the term (tᵢ), and the variable ave_doc_length represents an average document length of the documents in the document collection. In this particular example, the logarithmic term may be negative for terms that appear in more than half of the documents, so the logarithmic function may be replaced for particular implementations or the common terms may need to be treated as “stop words” that are ignored or omitted from such scoring. In an example, the logarithmic term can be replaced with the inverse-document-frequency equation depicted in Equation 10. In either case, refinement/weighting module 226 depicted in FIG. 2 can apply the BM25 ranking function to produce a ranking value that reflects a relationship between the terms and each document in the document space, which can be used to weight the particular mappings.

Once the refinement/weighting module 226 creates the weighted product-patent mappings 132, it may sometimes be desirable to further refine the mappings. For example, other data sources may include information that can be used to verify particular mappings, and/or to supplement the mappings. Further, some mappings may be more reliable than others. For example, a match between product owner data and patent assignee data may be more reliable as a relationship than an association defined by a concept mapping. Accordingly, refinement/weighting module 226 is configured to adjust weights for particular mappings to reflect their known reliability. Further, in some instances, other information may be available to confirm or bolster a particular relationship.

In an embodiment, the system may utilize data derived from whitepapers, manuals, web site information, and other documents to refine its understanding of a particular product by producing a semantic signature that can be used to search for semantically relevant patent documents. Such information can be located, extracted and analyzed automatically, using LSA or other types of analysis, to relate such information to the existing data and/or to adjust weights of particular mappings.

Additionally, as mentioned above, learner module 230 (depicted in FIG. 2) can be trained to identify relationships between various pieces of data. While the above examples have focused on mappings between product-patent mappings 132, it should be understood that such mappings are discussed for illustrative purposes only, and that correlation system 120 is adapted to map other types of data as well. Further, learner module 230 is configured to generate other mappings/rules, which can be used to dynamically relate new information to one or more sets of classifications, such as International Patent Classifications, Industry Classifications, proprietary classifications, and the like. Once the relationships are defined, they too can be stored as other mappings/rules and accessed to produce related data. Further, learner 230 can apply learned rules to dynamically determine associations for new data.

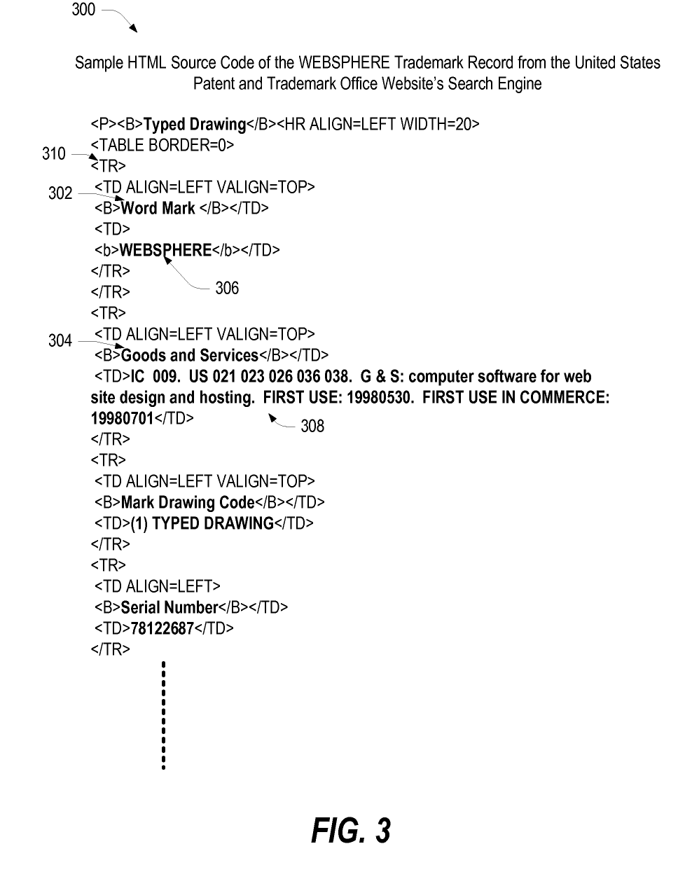

FIG. 3 depicts an embodiment of a trademark record 300 encoded with hypertext markup language (HTML) tags retrieved from the Trademark Electronic Search System (TESS) through the United States Patent and Trademark Office website. Often, a trademark is used to name a product, and the trademark record 300 thus includes some data that may useful in determining a relationship between a product and a patent document.

In the illustrated example, the trademark record 300 includes data for the trademark WEBSPHERE. The trademark record 300 includes data identifiers, such as “Word Mark” 302 and “Goods and Services” 304, interspersed with corresponding data items 306 and 308 and with hypertext coding, such as table row code “<TR>” 310.

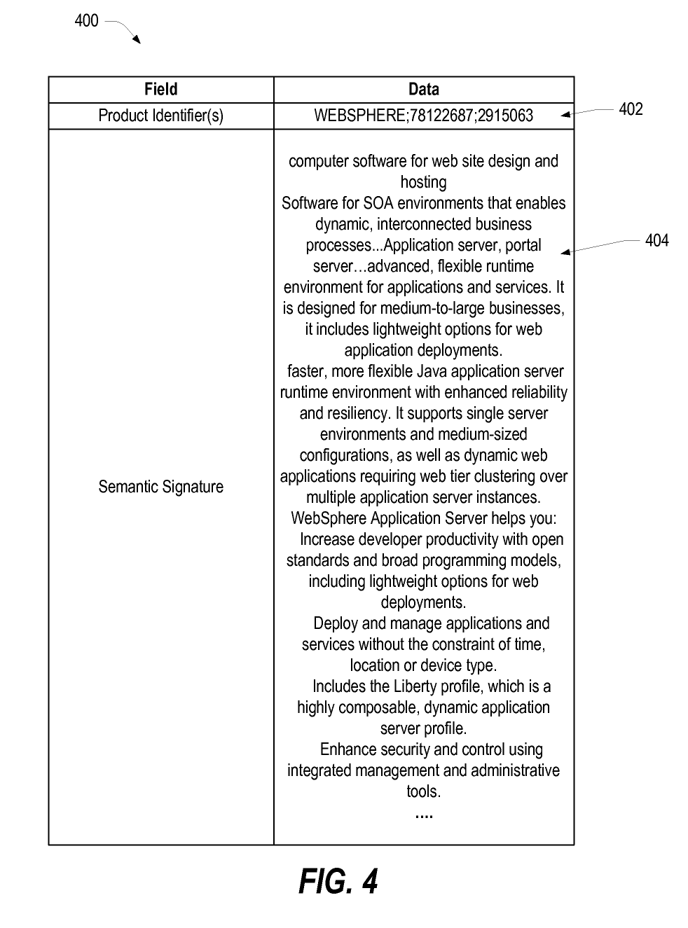

The ETL module 122, depicted in FIG. 1, removes the HTML coding and extracts the data 306 and 308, such as the mark “WEBSPHERE” and the associated text of the description of goods and services. In a structured data format such as that provided by search results from TESS, the field names can be derived from the tags or labels included within the HTML document. For example, the ETL module 122 could utilize data identifiers 302 and 304 as labels for the extracted data 306 and 308. In another example, the data identifiers 302 and 304 can be discarded, and the extracted data 306 and 308 can be populated into a pre-existing table or database, such as table 400 depicted in FIG. 4.

FIG. 4 depicts a table 400 including data extracted from the trademark record illustrated in FIG. 3. The table 400 includes pre-existing fields, though, as mentioned above, such fields could be derived from the data identifiers 302 and 304 depicted in FIG. 3. As can be seen in the table 400, the extracted data 308 that was extracted from trademark record 300 in FIG. 3 may require further processing. For example, the description of goods and services data 308 includes international trademark classification data “IC 009,” United States trademark classification data “US 021 023 026 036 038,” an abbreviation “G&S,” punctuation (such as colons and periods), and date information, including “FIRST USE: 19980530” and “FIRST USE IN COMMERCE: 19980701.” To utilize such information, it may be desirable to reorganize the received data into various fields or buckets. Accordingly, the ETL module 122 is adapted to process the extracted data and to transform the data. For the purpose of the semantic signature, a portion of the data 308 may be extracted and inserted into the semantic signature.

In some embodiments, the mark identifiers, such as the mark itself, its registration and application numbers, as well as other identifiers (such as a globally unique identifier) may be stored in a product identifier field 402 of the table 400. Further, text extracted from the trademark record may be included in the semantic signature field 404 together with text associated with the Websphere product extracted from other sources, such as patent documents, websites, whitepapers, and so on.

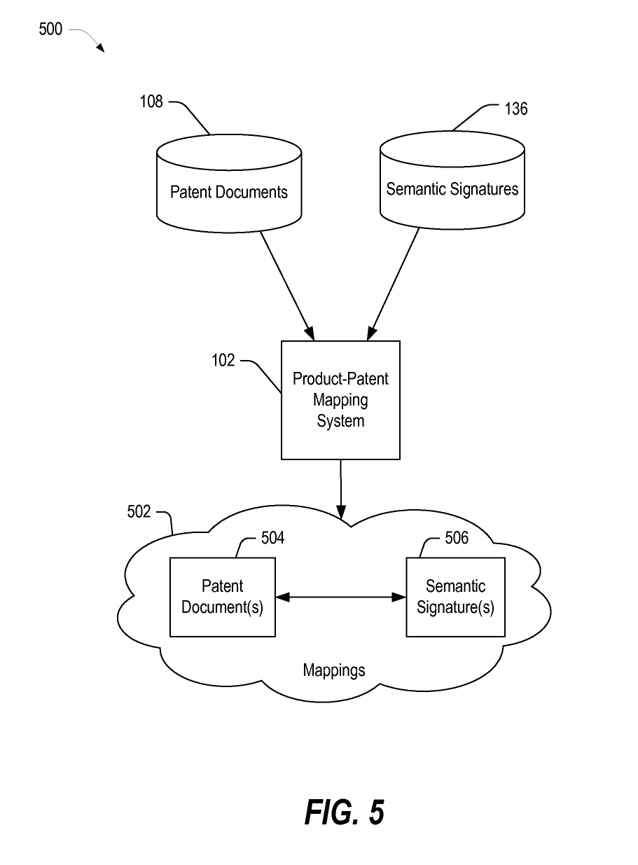

FIG. 5 is a block diagram of a system 500 to map products to patents according to some embodiments. The system 500 includes the product-patent mapping system 102, which may be configured to search patent documents 108 and semantic signatures 136 to identify a subset of patent documents 504 and a subset of semantic signatures 506, which relate to a particular concept. The correlation system 102 may process the subsets to produce product-patent mappings 502, which may be stored in a memory.

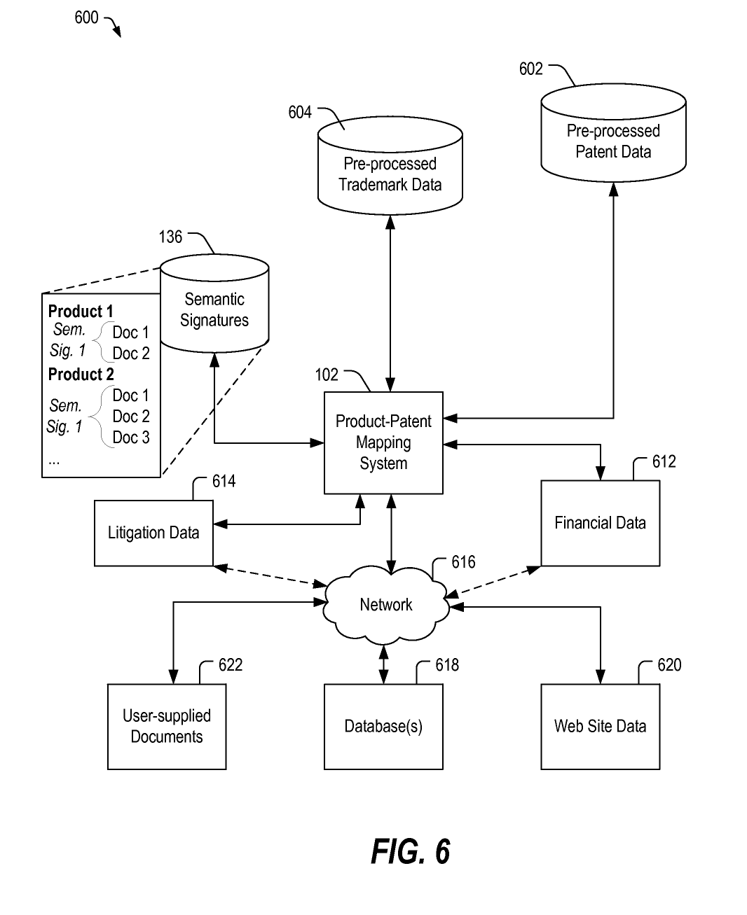

FIG. 6 is a block diagram of a system 600 configured to map products to patents according to some embodiments. The system 600 includes the product-patent mapping system 102 coupled to the pre-processed patent data 602, the pre-processed trademark data 604, the other data 114, and the semantic signatures 136. Further, the product-patent mapping system 102 is coupled to financial data 612, litigation data 614, various databases 618, web site data 620, and user-supplied documents 622.

The product-patent mapping system 102 may receive seed data, such as a patent number or a product identifier (e.g., the name of a commercial product). In response to a patent number, the product-patent mapping system 102 may retrieve a patent from the pre-processed patent data 602, may extract data from the patent, and may utilize the data to search the semantic signatures 136 to retrieve product data that relates to the patent. The extracted data may include claims, abstract, text corresponding to structure, or any combination thereof. The query may then be structured to search the semantic signatures 136 based on selected portions of the extracted data to retrieve product data related to the patent.

In some embodiments, in response to a product identifier, the product-patent mapping system 102 may retrieve a semantic signature corresponding to the product identifier from the semantic signatures 136. The product-patent mapping system 102 may generate a query based on statistically relevant terms within the semantic signatures 136 and may search at least the claim text of the pre-processed patent data 602 based on the generated query to retrieve patents that have claims that relate to the product. In some embodiments, the query may be expanded to encompass the entire patent text.

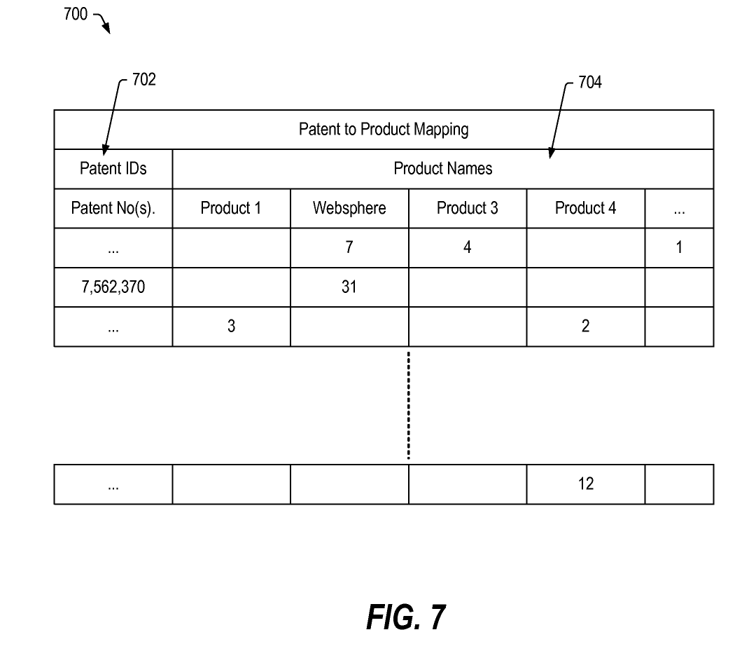

In some embodiments, the product-patent mapping system 102 may supplement the semantic signatures based on litigation documents, whitepapers, website data, data supplied by a user, or any combination thereof. The search results may be presented in a form that depicts a patent identifier and a product identifier. In some embodiments, the search results may be presented with a user-selectable link to supporting documents (from which the semantic signature was generated) that correspond to the element of the patent application. In some embodiments, the search results may indicate a number of supporting documents, which may be accessed, for example, by clicking on the number within the GUI. In the example presented below in FIG. 7, the product-to-patent mappings have been determined and a GUI may be presented that includes a mapping table showing the product-to-patent mappings.

FIG. 7 is a diagram of an example of a mapping table 700 indicating a relationship between patents and products according to some embodiments. Mapping table 700 includes a matrix of patent documents versus product identifiers. An indicator of a mapping between a particular patent document and a particular product may be provided using a letter, such as an “X”, or other marker. In some embodiments, the indicator may include a color code or a number. In some embodiments, the number may indicate a number of sources (supporting documents) from which the association was determined. In some embodiments, the indicator may also include a link to the supporting documentation

Further, mapping table 700 includes patent document identifier 702 (Patent ID) and products 704 to which the patent documents may be mapped. In some embodiments, multiple patent identifiers 702 may be provided as seed data, and the mapping table 700 may list all of the products that have been mapped to at least one of the patent identifiers. In the illustrated example, a patent identifier 7,562,370 is mapped to a product “Websphere” by 31 separate documents. In some embodiments, the mapping table may include term frequency data, and inverse document frequency data for each product relative to the patent document and to the set of patent documents, respectively. Further, correlation values may be calculated for each term relative to the patent. The correlation values, both raw and corrected (adjusted), may be determined from a combination of the term-frequency and inverse-document frequency values to provide a score, such as a raw score, a correlation score, another relevancy value, or any combination thereof, for each possible mapping. In another example, the product-patent mapping table 700 can include additional information and the numeric values within the table may be selectable by a user to access the underlying documents. In some embodiments, the mapping logic 124 may be adapted to generate multi-dimensional related tables that can include product data and patent and their weighted mappings defining relationships through one or more attributes as well as ancillary data, such as financial data attributable to the patent or the product, and so on.

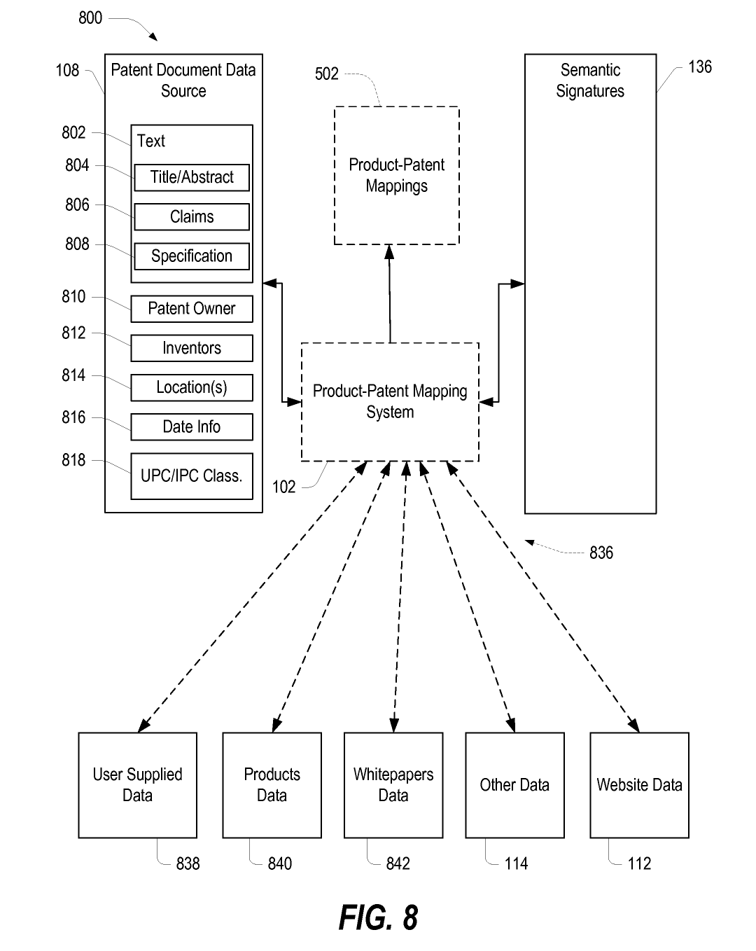

FIG. 8 is a block diagram of a system 800 configured to map products to patents according to some embodiments. The system 800 includes all of the elements of the product-patent mapping system 102 in FIGS. 1 and 2, including the

[symbol]

The product-patent mapping system 102 may have access to the patent document data source 108, semantic signatures 136, user-supplied data 838, products data 840, whitepapers data 842, other data 114, and website data 112. The product-patent mapping system 102 may receive data from one or more data sources and may process the data to produce a new semantic signature for storage within semantic signatures 136 or to supplement/refine an existing semantic signature within semantic signatures 136. In some embodiments, the semantic signature for a product may include a product name and excerpted text from various source documents that describe the product, such as manuals, websites, whitepapers, product literature, and so on. Some of that data may be user supplied, and some may be retrieved through directed web searches (such as searches directed at a website of the owner/manufacturer of a particular product. In some embodiments, the product-patent mapping system 102 may process semantic signatures against various attributes of the patent data within patent document data source, including text 802, title/abstract 804, claims 806, specification 808, patent owner 810, inventors 812, locations 814, data information 816, and class information 818, (e.g., U.S. Patent classifications (UPC), International Patent Classifications (IPC), proprietary classifications, industry classifications, other classifications, or any combination thereof). During such processing, the product-to-patent mapping system 102 may identify product-patent mappings 502, which may be stored in memory. Such mappings may be retrieved in response to a patent number or may be retrieved in response to a product identifier. In some embodiments, the product-patent mapping system 102 may identify a previously stored mapping in product-patent mappings 502 in response to a user query. The product-patent mapping system 102 may retrieve additional product information from the user-supplied data 838, the products data 840, the whitepapers data 842, the other data 114, the website data 112, or any combination thereof.

In some embodiments, the user may interact with a GUI (GUI) to select a mapping of a company's products to the company's patents. In another embodiment, the user may interact with the GUI to select a mapping of a list of the company's patents to products of another company that is specified by the user. In still another embodiment, the user may interact with the GUI to select a mapping of products to a particular company's patent portfolio. In still another example, the user may interact with the GUI to select a mapping of products to other company's patents, and so on. By providing such bi-directional mapping capability, the system 800 allows a user to map products to patents and/or patents to products to meet a variety of needs, from identifying offensive licensing opportunities, to documenting patent coverage for commercially available products, and so on. As mentioned above, the product-patent mappings may be used to provide a virtual patent marking and/or to produce documentation that may be used to earn tax rebates or to satisfy investors. Other uses are also possible, including verifying patent coverage, identifying potential infringement/licensing targets, and so on.

In some embodiments, the system 800 may generate a report, which may be presented as a web page within a user's web browser together with a plurality of user-selectable options. The user may interact with the user-selectable options to filter the report, for example, based on financial data, based on industry, based on patent strength quality metrics, and other information that may be included within the GUI. In an example, the user may wish to focus on products having an associated revenue generation value above a user-specified threshold. For example, if the financial data may be attributed to sales of a particular product, the user may apply a filter to limit the data displayed in the report to those products that exceed a particular threshold.

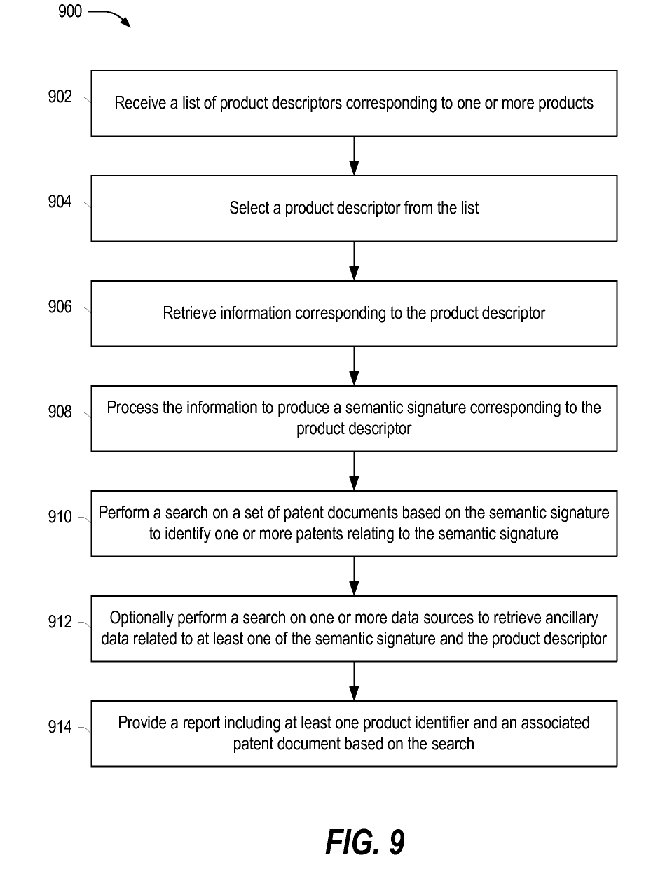

FIG. 9 is a flow diagram of a method 900 of relating products to patent documents according to some embodiments. At 902, a list of product descriptors is received that corresponds to one or more products. The list of products may be received from a user or may be identified by a first search. Alternatively, the list may be retrieved from a database based on seed data (such as a company name) from the user. Advancing to 904, a product descriptor (product identifier) may be selected from the list. The product descriptor may be selected automatically.

Continuing to 906, information corresponding to the product descriptor is retrieved. The information may be retrieved from one or more databases and/or from websites, including a website associated with the company that makes the product. Proceeding to 908, the information may be processed to produce a semantic signature corresponding to the product descriptor. In some embodiments, the semantic analysis module 126 processes the literature and retrieved text to produce a file (or document) including statistically relevant text and including a link to a cached version of the document. The resulting document may include aggregated text and data collected from various sources that relates to the product identifier, e.g., a semantic signature of the product. Moving to 910, a search is performed on a set of patent documents based on the semantic signature to identify one or more patents relating to the semantic signature. The search may be performed automatically based on a query generated from the semantic signature. In an embodiment, the search may be a directed search that may be performed on claims within the patent documents.

Continuing to 912, an ancillary search may optionally be performed on one or more data sources to retrieve ancillary data related to at least one of the semantic signature and the product descriptor. In an example, the search may be performed to retrieve financial data, litigation data, other information, or any combination thereof. Proceeding to 914, a report may be provided that includes at least one product identifier and an associated patent document based on the search.

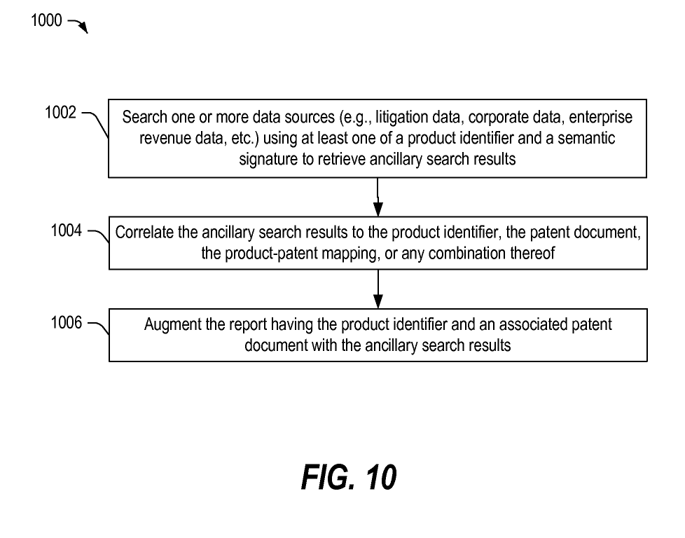

FIG. 10 is a flow diagram of the optional search 912 portion of method 900 in FIG. 9. Optional search 912 may be performed to augment the product-patent search results. At 1002, one or more data sources (such as litigation data, corporate data, enterprise revenue data, etc.) are searched using at least one of the product identifier and a query derived from the semantic signature to retrieve ancillary search results. The ancillary search results may include financial information attributable to each product, litigation data corresponding to the product and/or to the patent, and so on.

Advancing to 1004, the ancillary search results are correlated to the product identifier, to the patent document, to the product-patent mapping, or any combination thereof. Moving to 1006, the report having the product identifier and the associated patent document is augmented to include the ancillary search results. The report may then be sent to the user's device through the network, for example, as a GUI to be rendered within the user's Internet browser application.

In embodiment, the GUI may include one or more buttons, links, check boxes, or other user-selectable elements that the user may select to alter the displayed portion of the search results. In an example, the user may restrict the results based on financial information, such as an amount of earnings attributable to sales of a particular product. Alternatively, the user may select another option to trigger the system to perform a search of a specific company's patent portfolio, products, or other available data to map products to patents.

In accordance with various embodiments, the methods described herein may be implemented as one or more software programs running on a computer processor or controller. In accordance with another embodiment, the methods described herein may be implemented as one or more software programs running on a computing device, such as a personal computer. As used herein, the term “memory” or “data storage device” refers to a non-volatile data storage apparatus, such as a hard disk, flash memory device, compact disc, digital video disc, or other non-volatile storage media that may be used to store instructions and/or data. In some instances, memory may also refer to a volatile memory, such as a cache memory or processor memory that may temporarily store instructions and/or data during operation.

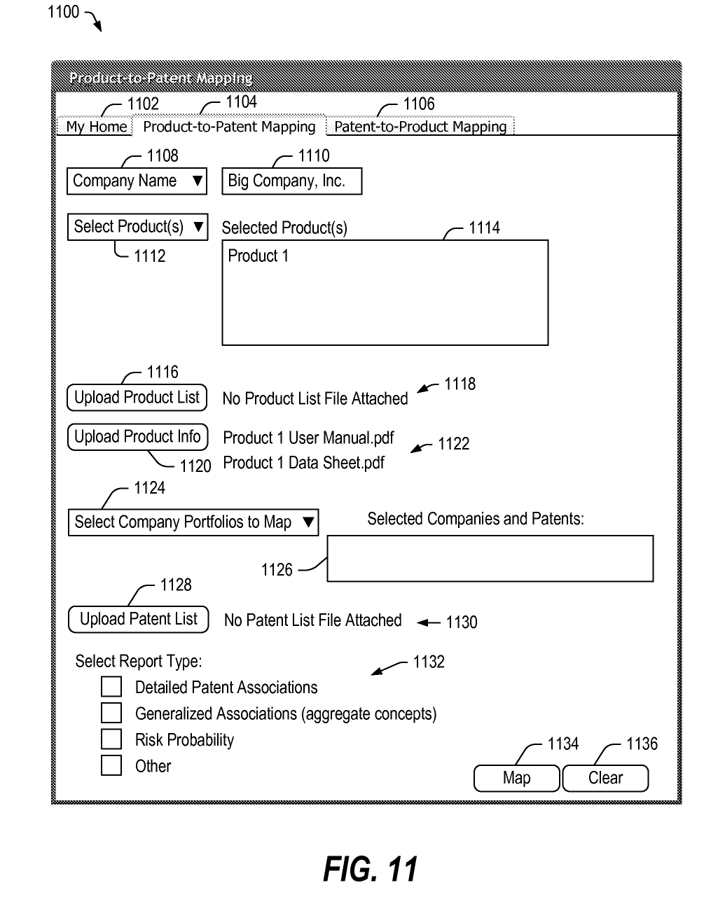

FIG. 11 depicts an embodiment of a GUI 1100 to map products to patents according to an embodiment. The GUI 1100 includes a first tab 1102 labeled “My Home”, a second tab 1104 labeled “Product-to-Patent Mapping”, and a third tab 1106 labeled “Patent-to-Product Mapping.” In the illustrated example, the second tab 1104 is selected and the corresponding panel is displayed.

The panel associated with the second tab 1104 includes multiple selectable elements, such as pull-down menus 1108 and 1112, a text input 1110, text boxes 1114 and 1126, and buttons 1116, 1120, 1134, and 1136. Further, the panel associated with the second tab 1104 includes check boxes that allow the user to select one or more reports or report types for generation of the product-to-patent mapping.

The pull down menu 1108 (labeled “Company Name”) may be accessed by a user to select one or more company names, which company names are already loaded and pre-processed in the system. Text input 1110 may be accessed by a user to type a company name (which may or may not be in the pull down menu 1108. If the user interacts with the pull down menu 1108 and/or text input 1110 and selects the button 1134 (labeled “Map”), the system may retrieve a list of products associated with the selected company (or companies) and associated semantic signatures and search multiple patent documents using the semantic signatures to identify patent documents corresponding to the list of products.

The pull down menu 1112 (labeled “Select Product(s)”) may be accessed by a user to select one or more product names, which product names are already loaded and pre-processed in the system. In an example, in response to the user selecting a company name using pull down menu 1108, the GUI 1100 may update pull down menu 1112 to provide a list of products corresponding to the company (or companies). When the user selects a product in pull down menu 1112, the selected product may be added to text box 1114, which may be configured to display the selected products.

The button 1116 (labeled “Upload Product List”) may be accessed by the user to open a file selection window through which the user may select a document for uploading to the system. The document may be a text file or a file formatted in a suitable format, such as a tab-delimited or comma-delimited format, an eXtensible Markup Language (XML) format, or other format. If a file is uploaded, text at 1118 may reflect the file name. In this example, the text at 1118 indicates that “No Product List File Attached”.

The button 1120 may be accessed by a user to provide additional information, such as documents, manuals, press releases, data sheets, and the like, which the user may have access to. Such information may be uploaded, and the file names may be indicated by text 1122. In the illustrated example, two documents corresponding to Product 1 have been uploaded including “Product 1 User Manual.pdf” and “Product 1 Data Sheet.pdf”. If multiple products are selected, a button 1120 may be provided for each product to allow the user to upload data specific to that product. Alternatively, in response to selecting button 1120, a pop up window may be opened allowing the user to select the file for uploading and the pop up window may include a check box list of the selected products to allow the user to select the check box or boxes that relate to the uploaded document.

In an example, the user may interact with pull down menu 1108 to select a company name, such as “Big Company, Inc.”, which name may be presented in text input 1110. The user may further interact with pull down menu 1108 to select one or more products. Alternatively or in addition, the user may interact with button 1116 to upload a list of product names and/or with button 1120 to upload documents describing the one or more products. The system may process the uploaded documents to append text from the uploaded documents to existing semantic signatures for the related products (based on user selection or based on a semantic analysis of the content of the uploaded documents). As discussed above, the system may generate a semantic signature for each product name based on available documentary information, including information previously scraped from web pages, product literature, and the like, and including uploaded information.

The pull down menu 1124 may be accessed by a user to select a company's patent portfolio to map. In particular, the user may interact with pull down menu 1124 to select one or more companies to map the selected products to the patent portfolios of the selected companies. The selected companies and patents may be listed in text box 1126. Selecting the button 1134 may cause the system to map the selected products to the selected company's patent portfolio.

The button 1128 (labeled “Upload Patent List”) may be accessed by a user to upload a list of patents, and the uploaded file may be indicated by text 1130. The selected products may be mapped to the uploaded list of patents. In such an example, the system may retrieve the patent documents corresponding to the list and may map the product to the retrieved patent documents.

Check boxes and report selection options 1132 may be accessed by the user to select a type of report with which to present the mapping results. In an example, it may be desirable to select a report that provides the mappings in terms of “aggregate concepts” or generalized technology associations so that the user is not inadvertently put on notice of an existing patent that a product may infringe. Thus, a user may select the “Generalized Associations” report to see a generalized or conceptual list of related patent subject matter. In another example, the user may select a risk probability report that may provide a list of patent documents listed according to possible threats to products. Detailed Patent Associations may be selected to see a mapping of products to patents and/or patent claims which may be used for licensing and/or litigation analysis. Alternatively, the report may be used to map a company's patents to its products to provide evidence that the products are covered by the patents. In an example, the evidence that the patents cover the company's patents may be used to seek tax benefits, for example, in the United Kingdom or other countries where such tax incentives may exist.

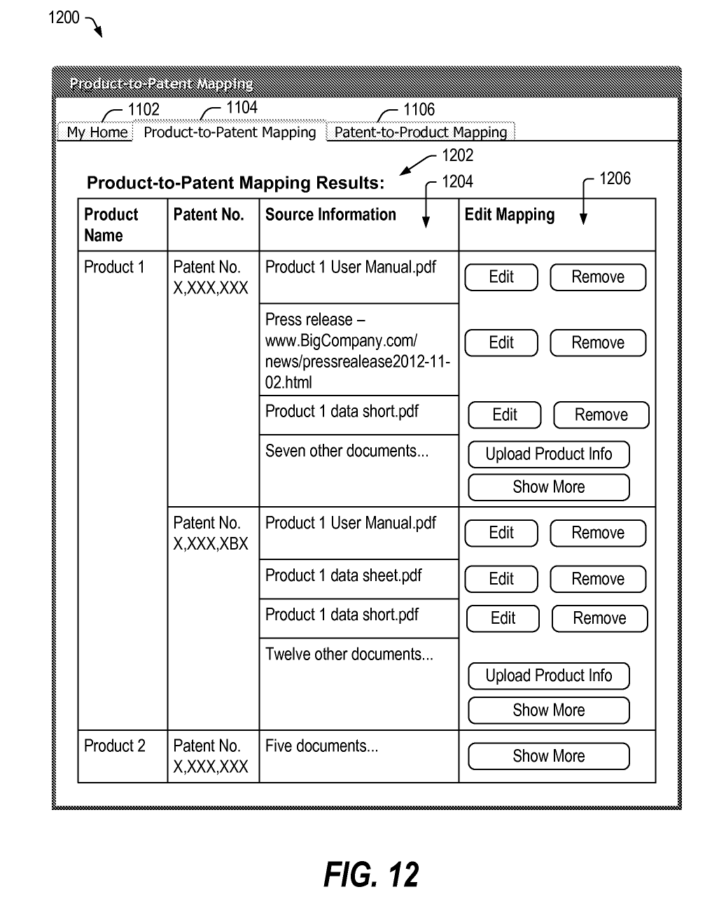

In the illustrated example, multiple selection options are presented on a single panel of the GUI 1100; however, in other embodiments, selection options may be contextual, such that selection of a particular company or feature may determine the other options available. For example, if no products are in the system for a particular company, the GUI 1100 may remove (or render accessible) pull down menu 1112 and text box 1114, leaving the user to either upload a product list using button 1116 or leaving it to the system to identify products for the particular company through a search operation. The retrieved data may then be processed to produce a semantic signature for each product, and the semantic signature may be used to map the products to patents. One possible example of the GUI 1100 including the results of one such mapping is described below with respect to FIG. 12.

FIG. 12 depicts an embodiment of the GUI 1200 of FIG. 11 including an example report 1202 showing products mapped to patents according to an embodiment. The example report includes a first column depicting the product names, such as “Product 1” and “Product 2”. The example report further includes a list of patents mapped to each product, source information 1204 providing support for the mapping, and user-selectable elements (such as “Edit” and “Remove” buttons to allow a user to modify or refine such supporting information. Further, the user may select a “Show More” button to see further supporting information or a “Upload Product Info” button to upload additional documents, which may be processed to modify the semantic signature for the product and which may be applied to the patent to refine the mapping.

It should be appreciated that the edit feature may allow the user to review the supporting text and to select excerpts from the text to provide further support. Further, other editing features may be presented, including a text box to allow the user to insert a comment and/or to annotate the mapping.

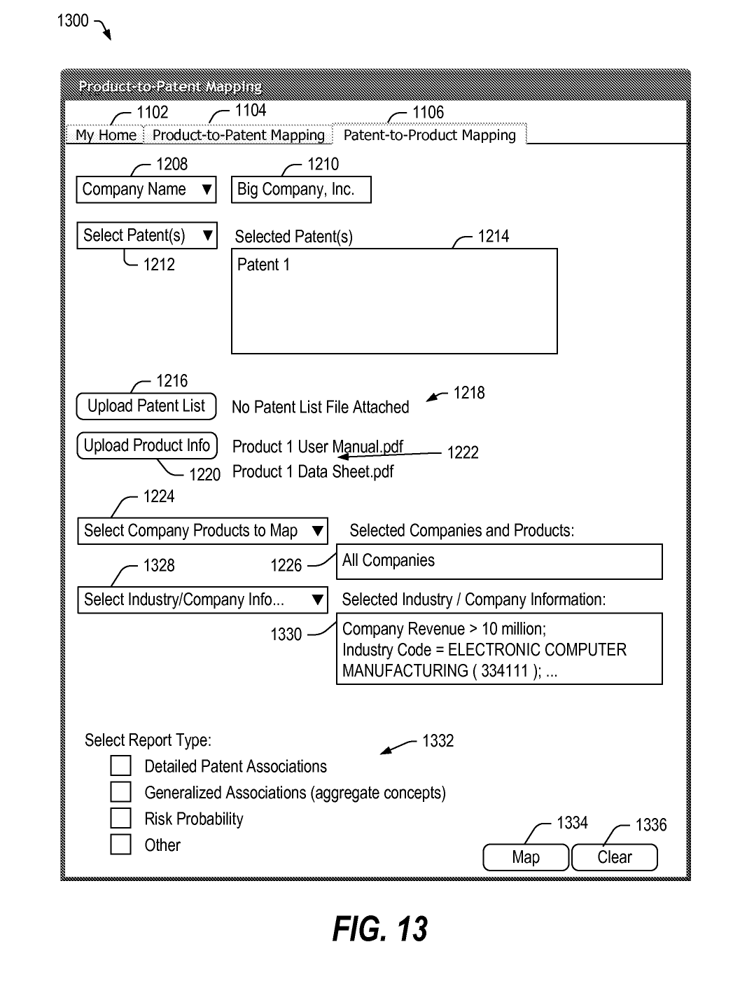

FIG. 13 depicts an embodiment of a GUI 1300 to map patents to products according to an embodiment. The GUI 1300 includes the tabs 1102, 1104, and 1106 of FIGS. 11 and 12; however tab 1106 (labeled “Patent-to-Product Mapping”) is selected.

The tab 1106 includes pull down menus 1308, 1312, 1324, 1328, and 1332, text input 1310, text boxes 1314, 1326, and 1330, and buttons 1316, 1320, 1332, 1338, and 1340. In this example, the user may select one or more companies by interacting with pull down menu 1308 and/or entering text in text input 1310. The user may select one or more patents using pull down menu 1312, which selected patents may be presented in text box 1314. The user may also upload a list of patents by selecting button 1316 (labeled “Upload Patent List”), and the uploaded list may be identified by text 1318. Further, the user may upload product information using button 1320 (labeled “Upload Product Info”), and the uploaded files may be identified by the text at 1322.

Further, the user may interact with pull down menu 1324 to select a company to which the user wants to map the selected patents, and the selected companies may be identified in text box 1326. Further, the user may utilize pull down menu 1328 (labeled “Select Industry/Company Info . . . ” to limit the scope of the mapping. For example, the pull down menu may include a list of filtering options, selection of which may cause GUI 1300 to present a pop up menu to select a desired filtering option. For example, the user may interact with the pull down menu 1328 to select a company revenue option and may define a revenue range to limit the scope of the mapping to products sold by companies having an annual revenue of greater than 10 million dollars (for example). Alternatively, the user may select an industry code (such as a North American Industry Classification System (NAICS)), causing user interface 1300 to open a window allowing the user to select an industry code from a list. In this example, the user has selected a NAICS code of 334111, which corresponds to the Electronic Computer Manufacturing industry. Other filters are also possible, including selecting by company size, industry, technological similarity, risk, revenue size, product attributes (number of users, annual revenue attributable to the product, etc.), and other parameters. The selected parameters may be displayed in text box 1330.

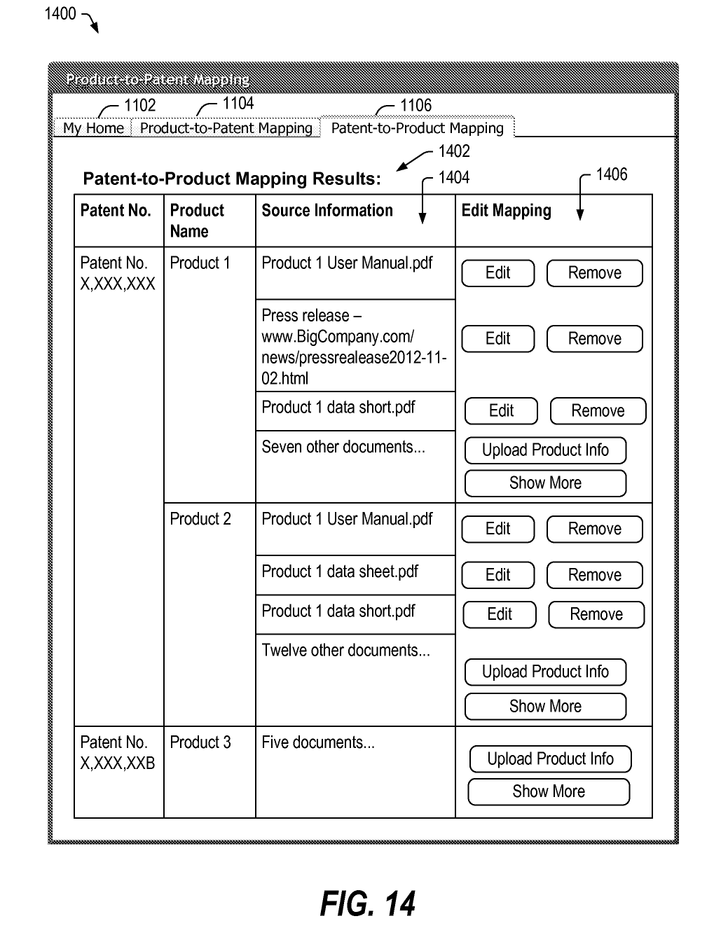

Further, tab 1106 allows the user to select a type of report, such as detailed patent associations, generalized associations, risk probability, or other types of reports. Via GUI 1300, the user may input a patent number or a company name and map the patent or patents to products. Further, the user may limit the mapping to types of companies, companies of a particular size or revenue level, to specific industries, and so on. One possible example of a resulting mapping of patents to products is described below with respect to FIG. 14.

FIG. 14 depicts an embodiment of the GUI 1300 of FIG. 13 including an example report showing products mapped to patents according to an embodiment. The example report includes a first column depicting the patent numbers, such as “X,XXX,XXX” and “X,XXX,XXB”. The example report further includes a list of products mapped to each patent, source information 1404 providing support for the mapping, and user-selectable elements (such as “Edit” and “Remove” buttons to allow a user to modify or refine such supporting information. Further, the user may select a “Show More” button to see further supporting information or a “Upload Product Info” button to upload additional documents, which may be processed to modify the semantic signature for the product and which may be applied to the patent to refine the mapping.

In the illustrated examples of FIGS. 11-14, the report is presented at a high level for simplicity. However, other reports are also possible. In a particular example, the patent-to-product mapping in FIG. 14 may be presented using an independent claim from patent number X,XXX,XXX in one column and the supporting document together with an excerpt of the relevant text from the supporting document in another column, presenting a draft claim chart mapping at least one of the patent claims to the product.

It should be appreciated that the edit feature may allow the user to review the supporting text and to select excerpts from the text to provide further support. Further, other editing features may be presented, including a text box to allow the user to insert a comment and/or to annotate the mapping.

While the examples depicted in FIGS. 11-14 represent two possible mapping processes, other possibilities may also be provided. In one example, in a product-to-patent mapping process, the user may provide a company name and may select the product for mapping from a resulting pull down menu. In another example, the user may provide a company name and upload product information. In still another example, the user may upload product information (i.e., a list of products), and the system will attempt to map the product information to a company and to map the product information to patents. In an embodiment, the output of the product-to-patent mapping process (such as that depicted in FIG. 12) may include patent associations with indicators specifying similarity of the products to the patents, optionally including linking information accessible by the user to drill down into the supporting information. Alternatively, the output may include general attributes (with no display of individual patents) including aggregate concepts (to avoid willful infringement issues). In this example, the aggregate concepts may be accessible by the user to drill down into more specific concepts. In another example, the output may include a risk probability, including patent litigation information, patent owner information (litigation history, competitive information, threat information, etc.), and other information. Further, the output may include user accessible control elements allowing the user to filter based on company size, industry, similarity, risk, revenue, specific products, and other attributes.

In a patent-to-product mapping, the user may specify a company name and may then select or list one or more patents of the company. The user may then interact with the user interface to filter the target results. In an example, the user may select one or more options to limit the target results to a target industry, to a particular type of company (company size, company industry, similarity, revenue size, product attributes (e.g., number of users), industry code, other information), to a specific company, a specific product, etc. Further, the user may exclude particular companies. The resulting output may include a claim mapping, with one or more claims of the patent mapped to corresponding product association (product name and supporting documentation). Further, the user may select one or more filtering options to narrow the results, for example, based on company revenue, company size, product attributes, industry code, or a company similarity score, a mapping score, other information, or any combination thereof. Further, the reports allow the user to refine the mappings, to upload additional documentation, and so on.

Data accumulated by the system through the GUI 1100 and 1400 may be further processed by the system to add to the semantic signature for the particular product, to refine the mapping, and so on.

As mentioned above, mappings between products and patent documents provide one possible example of a readily understandable set of mappings of unrelated or tangentially related documents. However, it should be understood that learner module 230 can control mapping logic 122 to generate relationship data to relate documents from all kinds of different sources, for example, through a set of pre-defined classifications or subject-matter categories, such as Industry classifications, International Patent Classifications, and the like. By training learner module 230 to generate such mappings, new data (such as data extracted from a user manual, a white paper, or a website, can be provided to learner module 230 and mapped to the existing classifications dynamically, without relying on pre-existing mappings. In this instance, International Patent Classifications, for example, can be used as a “Rosetta Stone” to relate search results between different data sources, across domains, between databases, between websites, and between various otherwise unrelated sets of search results.

Further, established mappings and those confirmed through user feedback can be stored for later use. In an example, interface 1400, within refinement portion 1406, can include feedback buttons to promote or demote various associations either within a particular search or globally. Such social voting could be used to refine mappings so that, over time, learner module 232 receives dynamic feedback from users to further refine its mapping logic and the existing mappings, such as product-patent mappings.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A data storage device comprising instructions that, when executed by a processor, cause the processor to:
generate a graphical user interface (GUI) including:
one or more bidirectional mappings between patents and products;
a plurality of user-selectable elements including at least one element selectable by a user to edit a selected one of the one or more bidirectional mappings; and
provide the GUI to a user device.

2. The data storage device of claim 1, further comprising instructions that, when executed, cause the processor to:
receive a user input corresponding to selection of the at least one element; and
provide a second GUI to receive information from the user corresponding to the selected one of the one or more bidirectional mappings.

3. The data storage device of claim 2, wherein the second GUI includes a document attachment option accessible by the user to upload a document.

4. The data storage device of claim 2, wherein the second GUI includes a text field accessible by the user to edit the selected one of the one or more bidirectional mappings.

5. The data storage device of claim 1, wherein the one or more bidirectional mappings comprises a table of results including a product identifier to identify a product, a patent identifier to identify a patent document, and an indicator of at least one document on which a bidirectional mapping between the product and the patent document is based.

6. The data storage device of claim 1, further comprising instructions that, when executed, cause the processor to:
provide a search GUI to the user device;
receive seed data from the user device in response to the search GUI; and
generate the one or more bidirectional mappings in response to the seed data.

7. A system comprising:
an interface to couple to a network;
a processor; and
a memory accessible to the processor, the memory to store instructions that, when executed by the processor, cause the processor to:
generate a graphical user interface (GUI) including:
one or more bidirectional mappings between patents and products;
a plurality of user-selectable elements including at least one element selectable by a user to edit a selected one of the one or more bidirectional mappings; and
provide the GUI to the network.

8. The system of claim 7, further comprising instructions that, when executed, cause the processor to:
receive a user input corresponding to selection of the at least one element; and
provide a second GUI to receive information from the user corresponding to the selected one of the one or more bidirectional mappings.

9. The system of claim 7, further comprising instructions that, when executed, cause the processor to provide a document attachment option accessible by the user to upload a document.

10. The system of claim 7, further comprising instructions that, when executed, cause the processor to:
receive a user input corresponding to selection of the at least one element; and
provide a text field accessible by the user to edit the selected one of the one or more bidirectional mappings.

11. The system of claim 10, further comprising instructions that, when executed, cause the processor to:
receive text corresponding to the text field; and
update the selected one of the one or more bidirectional mappings based on the received text.

12. The system of claim 7, wherein the one or more bidirectional mappings comprises a list of results including a product identifier to identify a product, a patent identifier to identify a patent document, and at least one document on which a bidirectional mapping between the product and the patent document is based.

13. The system of claim 7, further comprising instructions that, when executed, cause the processor to:
receive seed data from the network;
process the seed data to identify one or more bidirectional mappings between patents and products; and
generate the GUI in response to identifying the one or more bidirectional mappings.

14. The system of claim 13, wherein the seed data comprises at least one of a product identifier, a company identifier, and a patent identifier.

15. A method of providing bidirectional mappings between patents and products, the method comprising:
generating a graphical user interface (GUI) including one or more bidirectional mappings between patents and products and including a plurality of user-selectable elements, at least one element of the plurality of user-selectable elements accessible by a user to edit a selected one of the one or more bidirectional mappings; and
providing the GUI to the network.

16. The method of claim 15, wherein before generating the GUI, the method further comprises:
receiving seed data from a user device; and
processing the seed data to identify one or more bidirectional mappings of products and patents.

17. The method of claim 16, wherein receiving the seed data comprises receiving at least one of a product identifier, a patent identifier, and a company identifier.

18. The method of claim 16, wherein receiving the seed data comprises receiving a file including at least one of a product identifier, a patent identifier, and a company identifier.

19. The method of claim 16, wherein generating the GUI further includes:
providing at least one user-selectable option within the GUI to limit the one or more bidirectional mappings based on financial information associated with at least one of the product of the bidirectional mapping and an owner of the product; and
altering a presentation of the one or more bidirectional mappings in response to selection of the at least one user-selectable option.

20. The method of claim 16, wherein generating the GUI further includes:
providing a selectable element accessible by the user to access documents supporting a selected one of the one or more bidirectional mappings; and
in response to receiving a selection of the selectable element, presenting at least one of a list of the documents and an excerpt of at least one of the documents.
